(19) United States
(12) Patent Application Publication
(10) Pub. No.: US 2026/0203125 A1
(43) Pub. Date: Jul. 16, 2026

(54) DEPLOYMENT OF AN ARTIFICIAL INTELLIGENCE (AI) MODEL

(71) Applicant: Honeywell International Inc., Charlotte, NC (US)

(72) Inventor: Bhabesh Chandra Acharya, Bangalore (IN)

(21) Appl. No.: 19/023,370

(22) Filed: Jan. 16, 2025

(51) Int. Cl. G06F 9/50; G06F 8/60

(52) U.S. Cl. CPC G06F 9/5044; G06F 8/60; G06F 9/5055

(57) ABSTRACT

Techniques for deployment of an artificial intelligence (AI) model are described. In an aspect, system resource metrics of an edge device are obtained, where the system resource metrics of the edge device dynamically vary with respect to time. Further, metadata associated with the AI model to be deployed onto the said edge device is acquired. A possibility of deployment of the AI model is validated in correspondence to the metadata associated with the AI model and the system resource metrics of the edge device, where validating the possibility of deployment is indicative of determining whether the edge device is capable of hosting the AI model. On validating the possibility of deployment, at least one of deploying the AI model, altering the AI model for being compatible to be deployed, and deferring deployment of the AI model onto the edge device, is performed.

### BACKGROUND

Artificial Intelligence (AI) and Machine Learning (ML) technologies have become increasingly prevalent across various industries in recent years. These technologies enable complex data analysis, decision-making, and automation capabilities that can enhance efficiency and productivity in numerous applications. As AI and ML continue to evolve, there has been a growing trend towards deploying these technologies not only in centralized cloud environments but also on edge devices. Edge computing refers to the practice of processing data closer to its source of generation, often on devices located at the periphery of networks. Edge devices may include a wide range of hardware, from industrial controllers and smart cameras to HVAC systems and various Internet of Things (IoT) sensors deployed in field locations.

### SUMMARY

Aspects of the present subject matter provide techniques for deployment of an artificial intelligence (AI) model.

According to an example of the present subject matter, a method for deployment of an artificial intelligence (AI) model is provided. The method includes identifying an edge device for deploying the AI model, obtaining one or more system resource metrics of the edge device, where the one or more system resource metrics of the edge device dynamically vary with respect to time, and acquiring metadata associated with the AI model to be deployed. Further, the method includes validating a possibility of deployment of the AI model in correspondence to the metadata associated with the AI model and the one or more system resource metrics of the edge device. Validating the possibility of deployment of the AI model is indicative of determining whether the edge device is capable of hosting the AI model. On validating the possibility of deployment of the AI model, the method includes performing at least one of deploying the AI model onto the edge device, altering the AI model for being compatible to be deployed onto the edge device, and deferring deployment of the AI model onto the edge device.

According to another example of the present subject matter, a system for deployment of an artificial intelligence (AI) model is provided. The system includes at least one processor, a memory comprising instructions that, when executed by the at least one processor causes a model deployer to identify an edge device for deploying the AI model, obtain one or more system resource metrics of the edge device, where the one or more system resource metrics of the edge device dynamically vary with respect to time, and acquire metadata associated with the AI model to be deployed. Further, a deployment validator is to identify the edge device is incapable of hosting the AI model based on the metadata of the AI model and the one or more system resource metrics of the edge device. Accordingly, a model altering module is to determine at least one altering technique to transform the AI model to be deployable onto the edge device and alter the AI model in correspondence to the at least one altering technique identified to create an altered AI model. Thereafter, the deployment validator is to validate a possibility of deploying the altered AI model onto the edge device.

According to another example of the present subject matter, a non-transitory computer readable medium containing program instruction for deployment of an artificial intelligence (AI) model is provided, that, when executed, causes the processor to identify a plurality of edge devices for deploying the AI model, obtain one or more system resource metrics of each of the plurality of edge devices, where the one or more system resource metrics of each of the plurality of edge devices vary dynamically with respect to time, acquire metadata associated with the AI model to be deployed, determine a first set of edge devices amongst the plurality of edge devices where the AI model is compatible for deployment, determine a second set of edge devices amongst the plurality of edge devices where the AI model is incompatible for deployment and initiate simultaneous deployment of the AI model onto the first set of edge devices.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment 100 for deployment of an artificial intelligence (AI) model, in accordance with an example implementation of the present subject matter.

FIG. 2 illustrates an AI model deployment system, in accordance with an example implementation of the present subject matter.

FIG. 3 illustrates a schematic for AI model deployment, in accordance with an example implementation of the present subject matter.

FIG. 4 illustrates an example for deployment of a predictive maintenance model onto a device of a facility, in accordance with an example implementation of the present subject matter.

FIG. 5 illustrates an example method for deployment of an AI model, in accordance with an example implementation of the present subject matter.

FIG. 6 illustrates another example method for deployment of an AI model, in accordance with an example implementation of the present subject matter.

FIG. 7 illustrates another example method for deployment of an AI model, in accordance with an example implementation of the present subject matter.

FIG. 8(a) and 8(b) illustrates an example method for deployment of an AI model onto a microcontroller, in accordance with an example implementation of the present subject matter.

FIG. 9 illustrates another example method for deployment of an AI model, in accordance with an example implementation of the present subject matter.

FIG. 10 illustrates a non-transitory computer-readable medium for deployment of an AI model, in accordance with an example of the present subject matter.

### DETAILED DESCRIPTION

The present subject matter relates to techniques for deployment of an AI model.

Generally, development and training of AI/ML models typically occur in cloud environments, which provide substantial computational resources and storage capabilities. Cloud platforms often host repositories where trained models, along with their associated metadata, are stored. These models can then be deployed to edge devices for local execution. However, many a times, the size of these AI/ML models may be larger than the edge systems. Therefore, deployment of large and computationally heavy AI models on to edge systems may impact the performance of the edge systems. For example, such deployments may increase the risk of exhausting the available disk space. Additionally, even when the model has successfully persisted to the disk, there may be instances where the system encounters difficulties loading the model due to insufficient memory resources.

Also, prior to deploying a model onto an edge system, the characteristics and requirements of the model may be evaluated in relation to the specific capabilities and constraints of the target edge device. This assessment may include factors such as the model's size, computational demands, and resource requirements in comparison to the edge system's available processing power, memory, storage, and other relevant specifications. This evaluation, however, typically relies on static parameters, for example, based on what the edge device is designed to handle, which may not accurately represent the edge device's capability in terms of available resources in real-time. The resources of edge devices often exhibit dynamic characteristics, potentially fluctuating rapidly due to factors such as concurrent processes, network conditions, or hardware variations. Therefore, the processing capabilities of the edge device may change between the initial assessment and the actual deployment. In some cases, even if the model was initially deemed suitable for deployment based on the original evaluation, dynamic changes in the edge device's system resources may render the model unsuitable for deployment. Consequently, deploying the model under these altered conditions may lead to unexpected behavior of the edge device, impacting its performance or functionality in ways not anticipated during the initial assessment.

Furthermore, in some known approaches, if a model is determined to be unsuitable for deployment based on the initial assessment, the deployment action may simply be halted. However, this approach does not address the underlying problem that the edge device still requires the functionality provided by that model. Merely stopping the deployment process leaves the edge device without the necessary capabilities, potentially impacting its ability to perform the required tasks or provide essential services, leading to compromised user experience, or failure to meet operational requirements.

Accordingly, the present subject matter provides techniques for deployment of an artificial intelligence (AI) model. To enable seamless and efficient deployment of the AI model onto an edge device, the present subject includes identifying an edge device for deploying the AI model. On identifying the edge device, one or more system resource metrics which dynamically vary with respect to time, such as a CPU usage of the edge device or an available memory space of the edge device may be obtained. For example, the system may determine that a microcontroller has 64 KB of available RAM and is currently utilizing 30% of its CPU capacity. Further, metadata associated with AI model to be deployed on the edge device may be acquired. This metadata might include information such as the model's size and minimum hardware requirements.

Subsequently, a possibility of deployment of the AI model in correspondence to the metadata associated with the AI model and the one or more system resource metrics of the edge device may be validated. To validate the possibility of deployment of the AI model, a qualitative comparison and a quantitative comparison between the AI model and the edge device may be performed. For example, an operating system version of the edge device and a framework of the AI model, or a size of the AI model and a capacity of the edge device to host the said model may be compared. For instance, it may be determined whether the microcontroller has sufficient memory to store and run the AI model.

Based on such analysis, the AI model may be handled in various ways. In some aspects, the AI model may be deployed successfully if the edge device meets all the necessary requirements. In other cases, the AI model may need to be altered to better fit the capabilities of the edge device. Alternatively, the deployment of the AI model may be deferred if the edge device is currently unable to support it. In one example, the AI model which is initially deferred from deployment may be altered to be compatible with the edge device, and subsequently may be validated for deployment. This alteration process may involve modifying the model's size, complexity, or resource requirements to better match the capabilities of the target edge device. Thereafter, on successful validation, the AI model may be deployed onto the edge device through a secured and trusted connection to ensure the integrity and confidentiality of the AI model during the deployment process.

Therefore, techniques of the present subject matter facilitate enhanced and adaptive AI model deployment, which allow for more efficient use of edge device resources by ensuring that only compatible AI models are deployed. Such an approach minimizes the risk of system disruptions and performance issues on the edge devices. These techniques not only ensure an increased efficient use of edge computing resources, but also enhance the overall reliability of AI-driven operations in diverse environments. Furthermore, the flexibility to alter and re-validate models when needed allows for a wider range of AI capabilities to be deployed across various edge devices, expanding the scope and impact of AI applications across various fields such as industrial automation, smart buildings, and Internet of Things (IoT) ecosystems.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

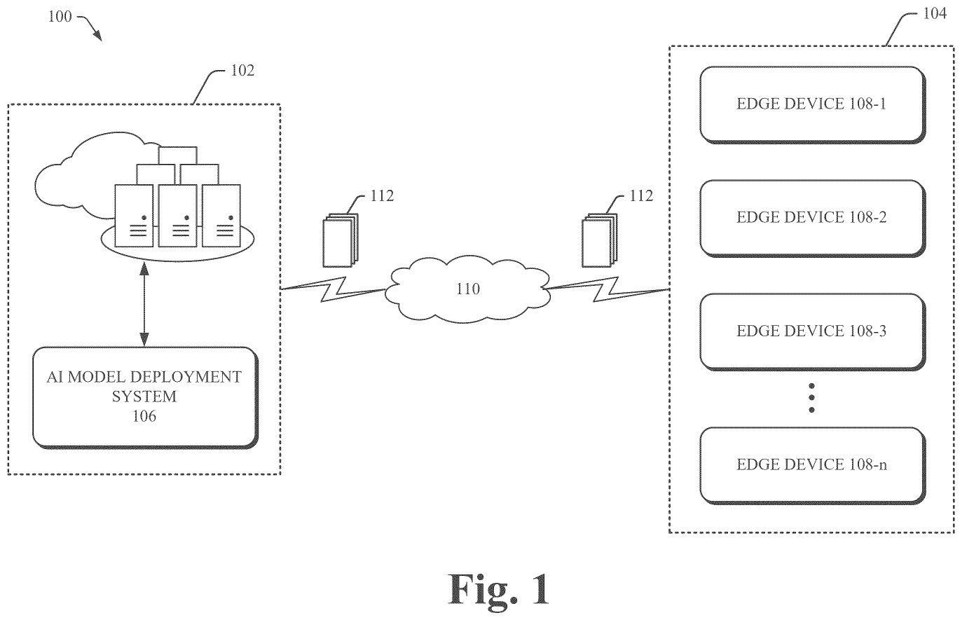

FIG. 1 illustrates a network environment 100 for deployment of an artificial intelligence (AI) model, in accordance with an example implementation of the present subject matter. In one example, the network environment 100 may include a cloud layer 102 and an edge layer 104. The cloud layer 102 may include a plurality of servers, data centers, storage systems, one or more computing systems, and the like. In one example, the components of the cloud layer 102 may include processors and a memory to store a plurality of software components that work together to provide a functionality, communicate with edge devices and/or other computing devices through network, and the like. In one example, the cloud layer 102 may be communicatively coupled to an AI model deployment system 106 which may be part of a source device (not shown in the figure), where the source device may be an Internet of things (IOT) device, a computing device, a personal computer, a laptop, a tablet, a mobile phone, and the like. In another example, the AI model deployment system 106 may be hosted on a server of the cloud layer 102 that may communicate with an edge device, and the like. Although not depicted, the AI model deployment system 106 may include other components, such as interfaces to communicate over the network or with external storage or computing devices, display, input/output interfaces, operating systems, applications, data, and other software or hardware components (not depicted for the sake of brevity). Additionally, the cloud layer 102 may also host data processing frameworks, machine learning platforms, and analytics tools to support AI model training and optimization.

The edge layer 104 includes a plurality of edge devices 108-1, 108-2, 108-3, . . . , 108-n, collectively and alternatively referred to as edge devices 108 or an edge device 108. In one example, edge devices 108 are devices which process data closer to its source of generation, often on devices located at the periphery of networks. These devices may vary in their computational capabilities and AI model execution abilities. For example, edge devices 108 may include industrial equipment such as Programmable Logic Controllers (PLCs), Human-Machine Interfaces (HMIs), industrial PCs, and robotic systems; sensing and monitoring devices such as smart cameras, various Internet of Things (IoT) sensors, environmental monitoring devices, and asset tracking tags; building management systems encompassing HVAC controllers, smart lighting systems, and access control devices; consumer and enterprise devices like smartphones, tablets, laptops, and personal computers, and the like. These devices may be deployed in various facilities, such as manufacturing facilities, warehouses, office buildings, field locations, or the like. In one example, edge devices 108 may have the capability to perform local data processing, run lightweight AI models, and execute real-time decisions while maintaining communication with the cloud layer 102. In one example, the capability to run AI models on these devices depends on various factors such as available computational resources, memory, power constraints, specific hardware optimizations, and the like.

In one example, the AI model deployment system 106 and the edge devices 108 may communicate over a network 110. The network 110 may be a wireless network or a combination of a wired and wireless networks, such as Ethernet, Local Area Network (LAN), Wide Area Network (WANs), Near Field Communication (NFC), satellite communications, Bluetooth networks, Zigbee networks. The network 110 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Also, in various implementations, the network 110 may employ multiple layers of security protocols and encryption standards to ensure secure communication between the cloud layer 102, the AI model deployment system 106, and the edge devices 108. The specific security measures implemented may vary based on the deployment environment, regulatory requirements, and the sensitivity of the AI models and data being processed. Depending on the terminology, the communication network includes various network entities, such as gateways and routers; however, such details have been omitted to maintain the brevity of the description.

In one example, in the process of AI model deployment, the cloud layer 102 typically hosts the AI model training and optimization processes, leveraging its substantial computational resources. The AI model deployment system 106 then prepares these models for deployment onto the edge device 108. Subsequently, the system utilizes the network 110 to securely transfer the AI models to the appropriate edge devices 108. These edge devices, with their varying capabilities, can then execute the deployed models locally, processing data at the source and making real-time decisions.

In one example, the AI deployment system 106 and the edge devices exchange data 112 through the network 110. In one example, the data 112 exchanged between the AI deployment system 106 and the edge devices, amongst other information, may include with system metrics from the edge devices, such as CPU usage, memory availability, and device identification; AI model metadata, including model size, framework supported, and version information; deployment requests and status updates; compressed or miniaturized AI models; validation results for proposed deployments; configuration parameters for the edge devices; performance data of deployed AI models; security credentials and authentication information; logs and diagnostic information; historical deployment data; updates or patches for the deployed AI models or edge device software, and the like.

In operation, to allow efficient use of edge device resources and minimizing the risk of edge device disruptions, techniques of the present subject matter obtain one or more system resource metrics of the edge device onto which the AI model is to be deployed. These system resources may include CPU capacity, available memory, and storage space, and the like. Further, a possibility for deploying the AI model onto the edge device is validated. This validation may be performed based on metadata associated with the AI model, such as model size and computational requirements, and the obtained system resource metrics. This process assesses the capability of the edge device to host and run the AI model effectively. Based on the validation results, the AI model may either be deployed onto the edge device or may be deferred from deployment. In cases where deployment is deferred, attempts to optimize the model further may be made, or attempts to postpone deployment until sufficient resources become available may be made. This validation process significantly enhances the reliability and efficiency of AI model deployment from the cloud layer 102 to edge devices 108 by preventing unsuccessful deployments and potential operational disruptions.

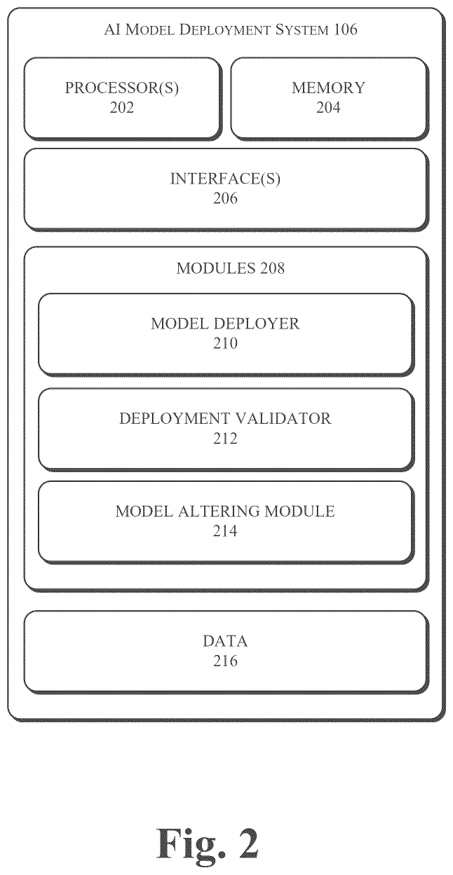

FIG. 2 illustrates the AI deployment system 106, in accordance with an example implementation of the present subject matter. The AI deployment system 106, alternatively referred to as system 106, is to enhance deployment of an AI model onto an edge device. In one example, the system 106 may include a processor 202 and a memory 204 coupled to the processor 202. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 206 may allow the connection or coupling of the system 106 with one or more other devices (such as edge devices), through a wired (e.g., Local Area Network, i.e., LAN) connection or through a wireless connection (e.g., Bluetooth®, Wi-Fi). The interface(s) 206 may also enable intercommunication between different logical as well as hardware components of the system 106.

The memory 204 may include any computer-readable medium including, for example, volatile memory (e.g., RAM), and/or non-volatile memory (e.g., EPROM, flash memory, etc.).

The system 106 may further include modules 208, such as a model deployer 210, a deployment validator 212, a model altering module 214, and the like. The module(s) 208, for example, may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 208. In such examples, the system 106 may include the machine-readable storage medium storing the instructions and the processing resource to execute the instructions. In other examples of the present subject matter, the machine-readable storage medium may be located at a different location but accessible to the AI model deployment system 106 and the processor 202.

The system 106 may further include data 216, that serves, amongst other things, as a repository for storing data that may be fetched, processed, received, or generated by the modules 208. In one example, the data 216 may be in both structured and unstructured data formats. The data 216 may include diverse types of information such as device metrics data such as CPU usage, memory utilization, disk space, and network bandwidth. It may also store model metadata, including model size, framework version, and runtime requirements, as well as deployment logs and history. Edge device specifications and capabilities, model performance metrics, and evaluation results may be included. The data 216 may also include user authentication and authorization information, configuration settings for the deployment process, and audit trails of deployment attempts and outcomes. Compressed model artifacts and associated metadata, system health and status information, and error logs for debugging purposes may be included. The data 216 may include API request and response data, telemetry data from edge devices, and version control information for models and system components. It may also include scheduled deployment task details, data transformation and preprocessing rules, model registry entries, metrics thresholds, deployment rules, and device connectivity status and history. In some cases, this data 216 may be stored in various formats such as relational databases, NoSQL databases, time-series databases, object storage, or file systems, depending on the specific requirements of each data type and its intended use within the system. In an example, the data 216 may be stored in the memory 204.

In one example, to deploy an AI model onto an edge device, the model deployer 210 may identify an edge device. In one example, an edge device may request for an AI model to be deployed to meet a certain functionality. Alternatively, a user may select the edge device for AI model deployment. The edge device may be identified using unique identifiers such as device ID, MAC address, IP address, or serial number. In some cases, the edge device may be registered in a device management system or inventory database, allowing for easy identification and tracking.

On identifying an edge device, one or more system resource metrics of the edge device may be obtained. In one example, the one or more system resource metrics may be obtained from the edge device, through a metrics agent deployed on the edge device. In another example, the one or more system resource metrics may be obtained from a metrics store hosted on the cloud, which obtains and publishes the one or more system resource metrics of edge devices. In one example, the system resource metrics of an edge device may include, for example CPU usage percentage, available memory (RAM), free disk space, and network bandwidth utilization, for battery-powered edge devices—battery level percentage, and the like. System resource metrics could also include, for example, but not limited to, GPU utilization percentage, temperature of key components like CPU and GPU in degrees Celsius, number of active processes, I/O operations per second, power consumption, network latency, and packet loss rate as a percentage, available storage read/write speed in MB/s, number of active network connections, CPU clock speed in GHz, system uptime in hours or days, number of running threads, cache hit/miss ratio, and interrupt rate per second, and the like. These metrics may be collected and analyzed to assess a current state and performance of an edge device, to enable intelligent analysis for deploying AI models or other workloads to the device.

On obtaining the one or more system resource metrics, the model deployer 210 may acquire metadata associated with the AI model to be deployed. For example, metadata associated with the AI model may include, for example but not limited to, model name, version number, creation date, the framework used to develop the model, such as TensorFlow, PyTorch, scikit-learn, or the like, input and output specifications, including data types and shapes, the model's architecture, such as the number and types of layers in a neural network, the size of the model file in megabytes or gigabytes and its format, performance metrics, hardware requirements for optimal performance, like minimum RAM or GPU specifications, the model's intended use case or domain, any licensing or usage restrictions associated with the model, and the like. On obtaining the metadata associated with the AI model to be deployed and the one or more system metrics associated with the edge device in real-time or near real-time, a possibility of deployment of the AI model onto the said edge device may be validated.

To validate the possibility of deployment of the AI model onto the edge device, the deployment validator, based on the metadata associated with the AI model and the one or more system resource metrics, may determine whether the edge device is capable of hosting the AI model. To determine whether the edge device is capable of hosting the AI model, in one example, the deployment validator 212 may perform at least one of a qualitative comparison and a quantitative comparison between the AI model and the edge device.

Quantitative comparison between the AI model and the edge device may involve evaluating measurable metrics to determine whether the device can support the model's requirements at a given point in time. This comparison may be based on the hardware requirements of the AI model and the available resources of the edge device. For example, multiple parameters such as storage capacity of the edge device, storage availability, available memory, processing power, and specialized hardware requirements, may be evaluated to determine compatibility and performance feasibility. In one example, the deployment validator 212 may assess whether the edge device's resources at the time of deployment of the AI model, meet or exceed the model's minimum requirements. For example, consider an AI model such as an image classification model with a size of 250 MB, requiring 1 GB of RAM for inference, a minimum CPU speed of 1.5 GHz, and no GPU requirement. This model might be compared against current availability of resources on an edge device with 4 GB of storage, 2 GB of RAM, a CPU speed of 2.0 GHz, and no GPU. In this comparison, the deployment validator 212 may assess whether the 250 MB model can fit within the current available storage amongst the 4 GB storage of the edge device, whether the device's 2 GB RAM is sufficient the model's 1 GB requirement based on the current availability, whether the device's 2.0 GHz CPU surpasses the model's 1.5 GHz minimum requirement, and whether the lack of GPU on the device matches the model's lack of GPU requirement. Based on this quantitative comparison, the deployment validator 212 may determine that the edge device has sufficient resources to accommodate the AI model, allowing the deployment process to proceed.

On the other hand, qualitative comparison between the AI model and the edge device involves assessing compatibility factors that are not entirely numerical but are important for successful deployment and operation. For example, this assessment may involve software and environmental considerations including operating system compatibility, required software frameworks or libraries, programming language versions, and specific runtime environments. For instance, consider an AI model to be deployed, which is developed using TensorFlow 2.5, designed to run on a Linux-based operating system. This model may be compared against the edge device running a custom Linux distribution. In this scenario, the deployment validator 212 may determine if the edge device's operating system is compatible with the model's Linux requirement. Additionally, the deployment validator 212 may also determine whether the necessary TensorFlow libraries and dependencies are available or can be installed on the edge device. In one example, the deployment validator 212 may also consider factors such as the device's ability to handle the model's input data format, or if any specific hardware acceleration support may be required by the model, compatibility with the device's existing software ecosystem, and the like. Based on this qualitative comparison, the deployment validator 212 may determine whether the model can be deployed or check whether any updates on the edge device are to be performed prior to deployment, for example check if additional TensorFlow libraries need to be installed before the model can be successfully deployed to the edge device, and the like.

Additionally, in one example, based on historical deployment data, the deployment validator 212 may determine whether the edge device would be capable of hosting an AI model. In one example, historical deployment data may include success rates of previous model deployments, average and maximum sizes of successfully deployed models, deployment duration and resource utilization during the process, post-deployment performance metrics, such as inference time and accuracy, frequency and types of errors encountered during or after deployment, compatibility issues with specific device hardware or software versions, model update history and associated performance changes, user feedback or reported issues related to deployed models, edge device resource availability patterns, and the like. For example, consider an industrial edge device that has previously hosted various AI models for quality control in a manufacturing process. The deployment validator 212 may analyze the historical deployment data from the past 6 months, which includes information about previously deployed models and their impact on system resources. For instance, this data may indicate that a first model, Model A, with 150 MB size, peak RAM usage of 1.2 GB and average CPU utilization of 30%, deployed six months ago, was successfully deployed with stable performance. A second model, Model B, with 300 MB size, peak RAM usage of 2.5 GB and average CPU utilization of 55%, deployed four months ago, was successfully deployed initially, but caused occasional system crashes due to memory constraints, and a third model, Model C, with 200 MB size, peak RAM usage of 1.8 GB and average CPU utilization of 40%, deployed two months ago, was successfully deployed with stable performance. Accordingly, for a new model, Model D, with the following requirements of 250 MB size, estimated peak RAM usage of 2.0 GB and estimated average CPU utilization 45% to be deployed onto the edge device, the deployment validator 212 may analyze historical deployment data associated with deployment of Model A, Model B, and Model C. Based on the historical deployment data associated with the said models, the deployment validator 212 may analyze that models similar in size and resource requirements to Model D (such as Model C) have been successfully deployed and operated on this edge device. However, models with higher RAM usage (like Model B) have caused stability issues. Based on such analysis, and the current availability of resources on the edge device, the deployment validator 212 may determine that Model D is likely to be compatible with the edge device, but it could be deployed with caution and potentially with some optimizations to reduce peak RAM usage. Therefore, analyzing historical deployment data provides valuable insights into the device's capabilities and potential limitations, allowing for more accurate predictions of deployment success and performance.

Furthermore, in one example, the deployment validator 212 may analyze historical statistical data associated with the availability of one or more system resource metrics of the edge device to assess whether the edge device is capable of hosting an AI model. For example, consider an AI model for predictive maintenance that requires consistent access to at least 2 GB of RAM and 60% CPU availability to perform real-time analysis. The deployment validator 212 may analyze the edge device's resource utilization and availability over the past 30 days, collecting data points every 5 minutes. For example, the historical statistical data with respect to RAM availability may indicate a mean of 3.2 GB, a minimum availability of 2.5 GB, and an average availability of 3.1 GB. Similarly, the historical statistical data with respect to CPU availability may indicate a mean availability of 65%, a minimum availability of 45%, and an average availability of 62%. Based on such analysis, the deployment validator 212 may determine that, for example, while the mean and average metrics meet the model's requirements, there are periods where the device's resources drop below the necessary thresholds. The minimum RAM availability of 2.5 GB is below the required 3 GB, and the minimum CPU availability of 45% is below the required 60%. Therefore, based on the current resource availability and the statistical data available for the edge device, the deployment validator 212 may validate the AI model to be unsuitable for deployment in it's current as-is form, which if deployed could lead to performance issues or interruptions in the model's operation.

Based on such analysis, when the deployment validator 212 determines that the edge device is capable of hosting the AI model, the deployment validator 212 may initiate deployment of the AI model onto the edge device. However, when the deployment validator 212 determines that the edge device is incapable of hosting the AI model, one or more actions may be taken. In one example, deployment of the AI model may be deferred. In one example, on deferral of deployment of the AI model, the system may continue to monitor the edge device's resources. The deployment may be re-attempted again at a later time when resource conditions on the edge device have changed favourably for deployment. In one example, one or more updates for the edge device may be recommended to be installed or updated to allow the edge device to host the AI model. Alternatively, when an edge device is determined to be incapable of hosting a particular AI model, the system may suggest alternative edge devices that may be capable of hosting the model, which may involve analyzing the capabilities of other available edge devices and identifying those that meet the requirements for hosting the AI model.

In another example, the AI model may be altered and re-validated for deployment. The model altering module 214 may determine at least one altering technique to transform the AI model to be deployable onto the edge device. For example, but not limited to, the altering techniques may include compressing or miniaturizing the model to decrease the size of the model, translating the model into a format which may be compatible to be hosted on the edge device, modifying the model by removing or simplifying certain features or capabilities of the model, pruning the model, and the like. By applying at least one altering technique, an altered AI model may be created. Subsequently, the deployment validator 212 may validate the altered AI model by methods as described above to determine whether the altered AI model is suitable for deployment on the edge device.

Therefore, techniques of the present subject matter provide enhanced and adaptive AI model deployment, which allow for more efficient use of edge device resources by ensuring that only compatible AI models are deployed, thereby minimizing the risk of system disruptions and performance issues on the edge devices.

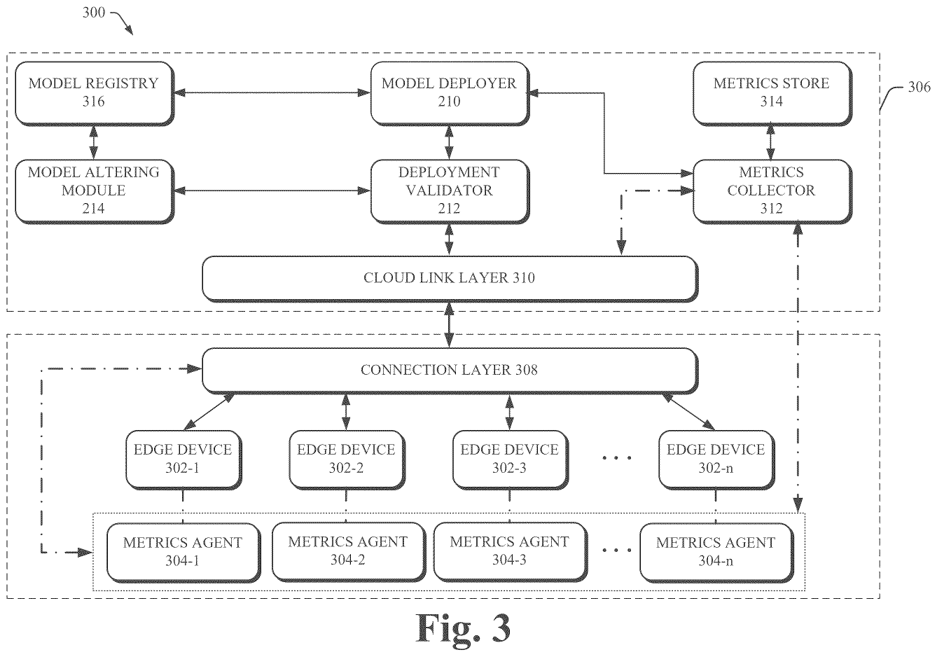

FIG. 3 illustrates a schematic 300 of the AI model deployment system, in accordance with an example implementation of the present subject matter. The following example elucidates deployment of an AI model onto edge devices of a facility 300, such as an industrial plant, and is not to be construed as a limitation. In one example, the facility 300 may include a plurality of edge devices 302-1, 302-2, 302-3, . . . , 302-4, collectively and alternatively referred to as edge device 302. The edge devices 302 may include, but are not limited to, programmable logic controllers (PLCs), industrial sensors, smart cameras, human-machine interface (HMI) panels, industrial gateways, embedded systems in manufacturing equipment, smart meters, industrial routers, edge servers, intelligent actuators, and the like.

The facility 300 may also include a plurality of metrics agents 304-1, 304-2, 304-3, . . . , 304-n, collectively and alternatively referred to as metrics agent 304. Each of the plurality of edge devices 302-1, 302-2, 302-3, . . . , 302-n, may be communicatively coupled to a metrics agent 304-1, 304-2, 304-3, . . . , 304-n, respectively. Alternatively, the edge devices the industrial plant may be communicatively coupled to a single metrics agent, or each metric agent may be communicatively coupled to a group of edge devices, and the like. In one example, the metrics agent 304 may be a part of the edge device 302. In another example, the metrics agent 304, may be a part of another source device (not represented in the figure), such as an Internet of things (IOT) device, a computing device, a personal computer, a laptop, a tablet, a mobile phone, and the like, which may be communicatively coupled to the edge device 302. In one example, the metrics agent 304 may collect system resource metrics of the corresponding edge device 302, such as real-time CPU and memory availability, and the like, which may then be published upstream to the cloud layer 306. The collected system resource metrics may be used to assess the current state of the edge device and its capacity to handle AI model deployments. For example, but not limited to, the metrics agent 304 may collect data from performance monitoring tools such as perfmon, system monitor such as Sysmon, Windows and Linux command-line utilities, Windows Management Instrumentation (WMI) calls, hardware sensors and counters, application-specific performance indicators, and the like. In one example, the metrics agent 304 may collect such data at regular pre-determined time intervals, for example every 5 minutes, or continuously in real-time, or near real-time. In one example, the metrics agent 304 may employ local data aggregation techniques to optimize the volume of data being transmitted upstream, and the like.

Further, a connection layer 308 of the facility 300 and a cloud link layer 310 of the cloud layer 306 may facilitate trusted and secure communication between the edge devices 302 of the facility 300 and the cloud layer 306 for both metrics collection and deployment of the AI model. The connection layer 308 may facilitate edge device registration and establishment of trusted connections between edge devices and the cloud layer 306. For example, the connection layer 308 may provide a channel for secure device onboarding and authentication, bi-directional communication, data encryption for metrics transmission, secure pathways for AI model deployment from cloud to edge devices, and the like. Similarly, the cloud link layer 310 may involve connecting to the connection layer 308 downstream to edge devices and upstream to cloud services. This layer may include mechanisms such as a proxy server to help protect against potential threats and attacks, and the like.

In one example, a metrics collector 312 of the cloud layer 306 may collect system resource metrics obtained from multiple sources and store the collected metrics in a metrics store 314. In one example, the metrics collector 312 may provide application programming interfaces (APIs) to allow other components or systems to query and retrieve the stored metric data. The centralized storage may enable historical analysis and trend tracking over time. In one example, the metrics collector 312 may collect system resource metrics through the connection layer 308, where metric agents 304 route the collected metrics via the connection layer 308 to reach cloud-based services. Alternatively, the metrics collector 312 may retrieve system resource metrics from a publish-subscribe (pub/sub) architecture or a message queue system, where the metrics agents 304 may publish collected data to specific topics or channels and the metrics collector may then subscribe to these topics to receive the relevant metric information.

In one example, the model deployer 210 may identify an edge device 302 amongst the plurality of edge devices 302 for which an AI model is to be deployed. Accordingly, one or more system resource metrics from the metrics store 314 for the said edge device 302 may be obtained. The model deployer 210 may obtain the AI model and metadata associated with the model, for example, from a model registry 316. The model registry 316 may include AI models, datasets that are trained and their parameters, physical model artifacts, and the like. In one example, the model registry 316 may also include an API layer for searching and updating model information. In another example, based on physical files of the model, a container image of the model may be built, where the physical files of the model may be considered as input for building the container image. On building the container image, a size of the container image along with its metadata may be stored in the model registry, which may later be acquired for further usage. Further, in one example, the model deployer 210 may version the model, conduct scans such as malware scans, twist lock scans, and also invoke components that may be needed for validation of deployment of the AI model.

To initiate deployment, the deployment validator 212 may validate a possibility of the edge device 302 being capable of hosting the AI model. Validating the possibility of deployment may include performing a qualitative comparison and a quantitative comparison between the edge device 302 and the AI model. For example, validation checks may include checking for model metadata in terms of model size, framework of the model and whether the edge device is capable of supporting the framework, whether the CPU and memory availability of the edge device would be sufficient for the model to be deployed and perform stably, and the like. Further, in one example, the deployment validator 212 may employ various rules and thresholds, such as requiring the edge device to have at least 1.5 times the memory size of the AI model available as free memory, or assessing CPU utilization with a threshold set at 70% average utilization over the past hour to ensure adequate processing capacity, or evaluating storage capacity requiring at least twice the AI model's file size in free space, or checking temperature thresholds such as ensuring the device's operating temperature below 80% of its maximum rated temperature, or the like, to determine whether the device is capable of hosting the model.

Based on such analysis, the deployment validator 212 may perform at least one of initiating deployment of the AI model or deferring the deployment of the model. On deferring the deployment of the AI model, in one example, the AI model may be altered to be made compatible with the edge device 302. In one example, the model altering module 214 may determine at least one altering technique to transform the AI model to be deployable onto the edge device. For example, but not limited to, the altering techniques may include compressing or miniaturizing the model to decrease the size of the model or translating the model into a format which may be compatible to be hosted on the edge device, and the like. In one example, the altered AI model may be stored in the model registry. In one example, the altered AI model may be re-validated for deployment onto the edge device. On validation of the AI mode, the model deployer may initiate the model to be deployed through the connection layer, onto the edge device 302.

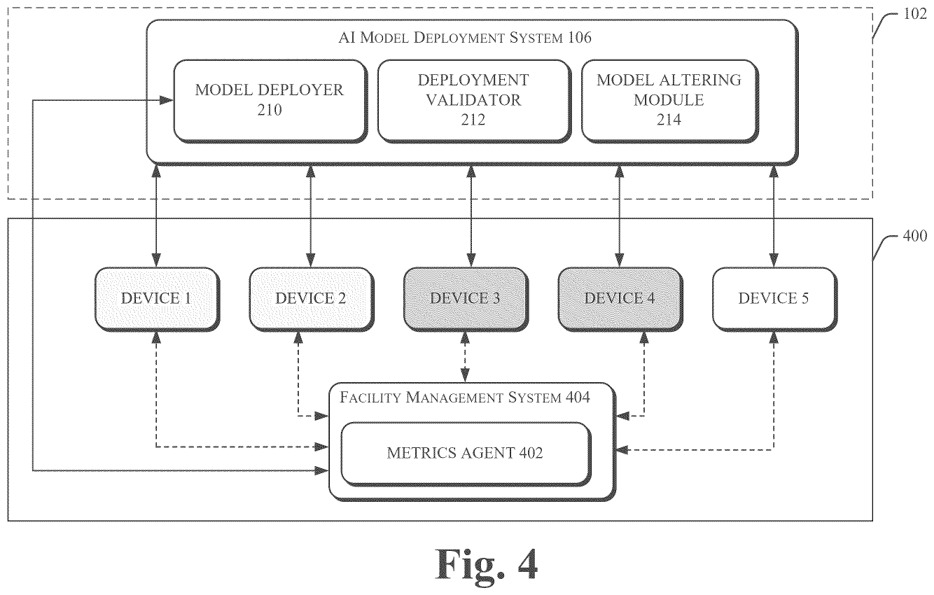

In one example, the model deployment may not be restricted to a single device. In one example, the model may be deployed onto multiple devices simultaneously, as discussed with reference to FIG. 4. Although the following example has been discussed predominantly based on deployment of one model onto multiple devices, it may be understood that similar principles of the present subject matter would be applicable to multiple models being deployed onto multiple devices simultaneously.

FIG. 4 illustrates simultaneous deployment of an AI model onto multiple devices, in accordance with an example implementation of the present subject matter. In one example, the industrial plant 400 may include multiple edge devices installed throughout the facility 400. For instance, five devices—Device 1, Device 2, Device 3, Device 4, and Device 5, may be identified for deployment of a predictive maintenance model. In one example, the predictive maintenance model may be deployed from the cloud layer 102.

In one example, one or more system resource metrics from each of these devices, including CPU usage, available memory, and storage capacity, may be obtained by the model deployer 210. These metrics may be dynamically updated as the devices perform their parallel operations. In one example, a metrics agent 402 may collect the system resource metrics. The metrics agent 402 may be a part of a facility management system 404 of the facility 400, and the facility management system 404 may be communicatively coupled to the AI model deployment system 106. In another example, the metrics agent 402 may be hosted on a server and may be communicatively coupled to the facility management system 404.

In one example, on obtaining the one or more system resource metrics associated with Devices 1-5, the AI model deployment system 106 may acquire metadata associated with the predictive maintenance model to be deployed. In one example, metadata associated with the predictive maintenance module may include a size of the model, required computational resources, compatible operating systems, and the like. Based on this data, the deployment of the model may be validated.

In one example, to validate a possibility of deployment of the predictive maintenance model onto Devices 1 to 5, the deployment validator 212 may perform a compatibility assessment between the devices and the model to determine whether each device is capable of hosting the model. In one example, a qualitative comparison and a quantitative comparison may be performed between the each of the devices and the AI model. For example, validation checks, such as checking for model metadata in terms of model size, framework of the model and whether the edge device is capable of supporting the framework, whether the CPU and memory availability of the edge device would be sufficient for the model to be deployed and perform stably, and the like, may be performed. Based on such an analysis, it may be determined that some of the edge devices out of the five edge devices may be capable of hosting the predictive model, while the other edge devices may be incapable of hosting the predictive maintenance model in its current as-is form.

Accordingly, based on this determination, the edge devices may be categorized into a first set of devices and a second set of devices. For example, the first set of devices may include those edge devices that are compatible for immediate deployment of the predictive maintenance model and the second set of devices may include those edge devices that are initially incompatible for deploying the predictive maintenance model. For instance, the first set of devices may include Device 3 and Device 4, identified as capable of hosting the predictive model without any modifications and the second set of devices may include Device 1, Device 2, and Device 5, identified as incapable of hosting the model.

Further, in one example, a third set of devices amongst the second set of devices may be identified, where the third set of devices may include devices for which the predictive model could be altered to fit their resource constraints. For example, Device 1 and Device 2 may be categorized as the third set of devices, for which the predictive maintenance model may be compressed, optimized, or otherwise modified to enable deployment onto these devices. In some cases, certain devices may exhibit severe resource limitations or incompatibility issues which may prevent deployment even after potential modifications. For instance, Device 5 may exhibit severe resource limitations.

In such scenarios, the predictive model may be deployed simultaneously to Device 3 and Device 4. The model altering module 214 may alter the predictive maintenance models to fit the constraints of Device 1 and Device 2, respectively, and then the altered models may be deployed onto the said devices simultaneously. Further, in this example, the deployment of the predictive model onto Device 5 may be deferred due to severe resource limitations on Device 5. Therefore, by dynamically assessing the compatibility of multiple edge devices, techniques of the present subject matter initiate deployment where possible and identify opportunities for model alteration to expand deployment coverage. The system 106 may continuously monitor device conditions and update its deployment decisions accordingly.

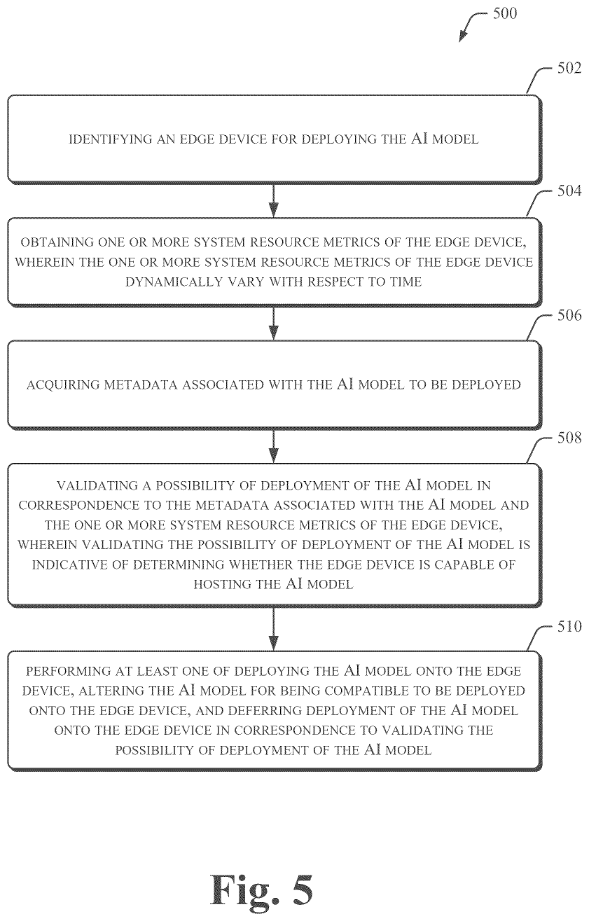

FIGS. 5, 6, 7, 8(a), 8(b), and 9 illustrate methods 400, 500, 600, 700, 800, and 900 for deployment of an AI model, in accordance with examples of the present subject matter. The order in which the methods are described is not intended to be construed as a limitation, and any number of the described method blocks may be combined in any order to implement the methods, or an alternative method. Further, the methods 400, 500, 600, 700, 800, and 900 may be implemented by processing resource or computing device(s) through any suitable hardware, non-transitory machine-readable instructions, or combination thereof.

It may also be understood that methods 400, 500, 600, 700, 800 and 900 may be performed by programmed computing devices, such as the AI model deployment system 106, as depicted in FIGS. 2, 3, and 4. Furthermore, the methods 400, 500, 600, 700, 800 and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 400, 500, 600, 700, 800 and 900 are described below with reference to the AI deployment system 106, as described above; other suitable systems for the execution of these methods may also be utilized. Additionally, implementation of the method is not limited to such examples.

FIG. 5 illustrates an example method for deployment of an AI model, in accordance with an example implementation of the present subject matter. In FIG. 5, at block 502 the method 500 includes identifying an edge device for deploying the AI model.

At block 504, the method 500 includes obtaining one or more system resource metrics of the edge device, where the one or more system resource metrics of the edge device dynamically vary with respect to time. In one example, system resource metrics may include CPU usage, memory utilization, available disk space, network bandwidth, and the like, which continuously vary in correspondence to an operation being performed by the edge device.

At block 506, the method 500 includes acquiring metadata associated with the AI model to be deployed. In one example, metadata associated with the model may include model name, version number, creation date, the framework used to develop the model, and the like.

At block 508, the method 500 includes validating a possibility of deployment of the AI model in correspondence to the metadata associated with the AI model and the one or more system resource metrics of the edge device. Validating the possibility of deployment of the AI model is indicative of determining whether the edge device is capable of hosting the AI model. In one example, determining whether the edge device is capable of hosting the AI model further includes performing at least one of a quantitative comparison and a qualitative comparison to assess a compatibility of the AI model and the edge device. Quantitative comparison includes assessing whether a framework of the AI model is compatible with an operating system (OS) version of the edge device and qualitative comparison includes assessing whether a size of the AI model to be deployed onto the edge device is compatible with a capacity of the edge device to host the AI model.

At block 510, the method 500 includes performing at least one of deploying the AI model onto the edge device, altering the AI model for being compatible to be deployed onto the edge device, and deferring deployment of the AI model onto the edge device in correspondence to validating the possibility of deployment of the AI model. In one example, altering the AI model for being compatible to be deployed onto the edge device includes at least compressing the AI model from a first size to a second size, where the second size is compatible with the edge device. Further, in one example, deploying of the AI model onto the edge device is performed through a trusted connection layer established between a cloud layer and the edge device to facilitate remote deployment to the edge device.

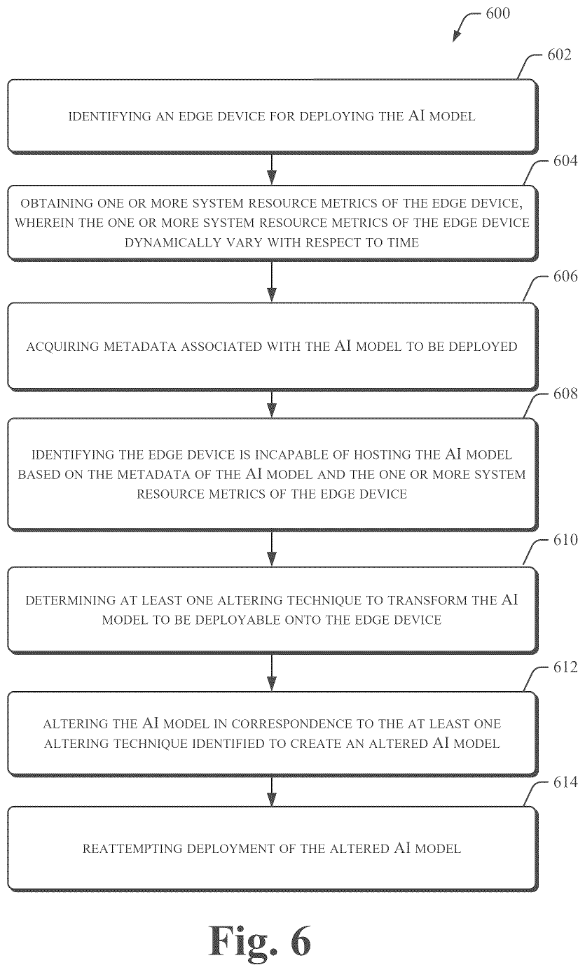

FIG. 6 illustrates another example method 600 for deployment of an AI model, in accordance with an example implementation of the present subject matter. In FIG. 6, at block 602, the method 600 includes identifying an edge device for deploying the AI model.

At block 604, the method 600 includes obtaining one or more system resource metrics of the edge device. In one example, system resource metrics may include CPU usage, memory utilization, available disk space, network bandwidth, and the like, which continuously vary in correspondence to an operation being performed by the edge device.

At block 606, the method 600 includes acquiring metadata associated with the AI model to be deployed. In one example, metadata associated with the model may include model name, version number, creation date, the framework used to develop the model, and the like.

At block 608, the method 600 includes identifying the edge device is incapable of hosting the AI model based on the metadata of the AI model and the one or more system resource metrics of the edge device. For example, the method may determine that an edge device running an older version of an operating system is incapable of hosting an AI model developed using a newer machine learning framework that is incompatible with the older operating system.

At block 610, the method 600 includes determining at least one altering technique to transform the AI model to be deployable onto the edge device. In one example, the altering technique may include compressing or miniaturizing the model to decrease the size of the model, translating the model into a format which may be compatible to be hosted on the edge device, modifying the model by removing or simplifying certain features or capabilities of the model, pruning the model, and the like. For instance, the method may determine that translating the AI model from its current framework to an older, more widely compatible framework would allow it to run on the edge device's older operating system.

At block 612, the method 600 includes altering the AI model in correspondence to the at least one altering technique identified to create an altered AI model. Continuing the example, the method may convert the AI model from its original framework to a more universally compatible format, and then further translate it into a framework that is compatible with the edge device's older operating system.

At block 614, the method 600 includes reattempting deployment of the altered AI model. In this example, an attempt to deploy the translated AI model, now compatible with the edge device's older operating system, onto the edge device, may be made. In another example scenario, if the reattempted deployment fails, a different altering technique to make the AI model deployable onto the edge device may identified. For example, a different altering technique, such as model compression or pruning, partitioning the model to deploy part on the edge device and part in the cloud, or temporarily deploying a simplified version of the model, and the like may be employed.

In one example, on successful deployment, the model's performance and resource usage on the edge device may be monitored and analyzed. In one example, real-time metrics on CPU usage, memory utilization, inference latency; comparing the model's performance against predefined thresholds or baseline metrics; analyzing the impact of the deployed model on other processes running on the edge device; detecting any degradation in model accuracy or efficiency over time, and the like may be monitored and analyzed. Based on such analysis, in one example, adjustments of the model may be initiated, such as further model optimization, or a redeployment process may be triggered to maintain optimal performance and compatibility with the edge device.

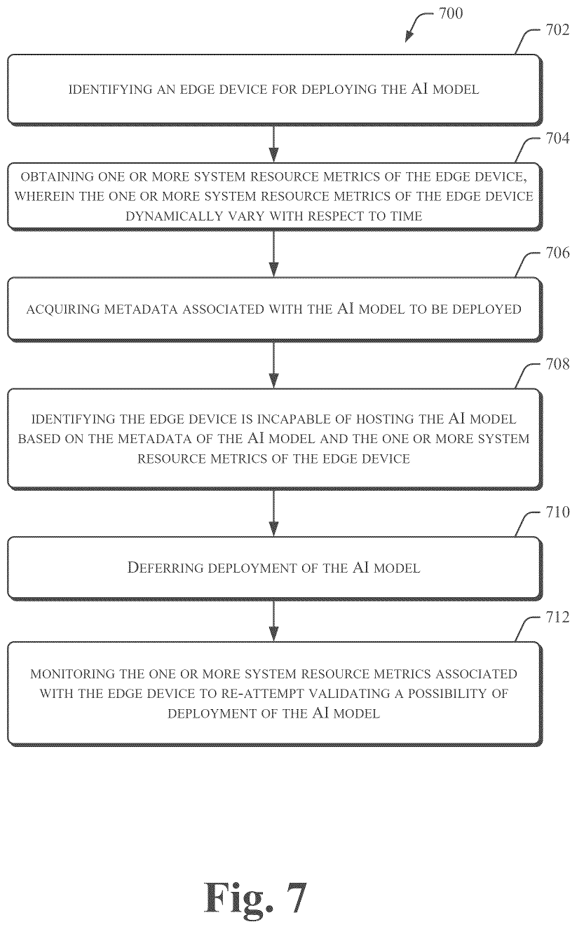

FIG. 7 illustrates another example method 700 for deployment of an AI model, in accordance with an example implementation of the present subject matter. In FIG. 7, at block 702, the method 700 includes identifying an edge device for deploying the AI model.

At block 704, the method 700 includes obtaining one or more system resource metrics of the edge device. In one example, system resource metrics may include CPU usage, memory utilization, available disk space, network bandwidth, and the like, which continuously vary in correspondence to operations being performed by the edge device.

At block 706, the method 700 includes acquiring metadata associated with the AI model to be deployed. In one example, metadata associated with the model may include model name, version number, creation date, the framework used to develop the model, and the like. For example, the metadata of the AI model may indicate that it requires at least 2 GHz of CPU processing power to operate efficiently.

At block 708, the method 700 includes identifying that the edge device is incapable of hosting the AI model based on the metadata of the AI model and the one or more system resource metrics of the edge device. This identification may involve comparing the requirements specified in the AI model's metadata with the current capabilities of the edge device as indicated by its system resource metrics. For example, the method may evaluate whether the edge device's available CPU processing power, memory, storage space, or network bandwidth meet the minimum requirements of the AI model. If any of these resources fall short of the model's needs, the edge device may be deemed incapable of hosting the AI model at that time. This step ensures that AI models are only deployed to edge devices that can effectively support their operation, preventing performance issues or system failures that could result from deploying models to under-resourced devices.

At block 710, the method 700 includes deferring the deployment of the AI model. For example, while the metadata of the AI model indicates that it requires at least 2 GHz of CPU processing power to operate efficiently, the system resource metrics may indicate that the edge device's CPU is currently operating at 90% capacity with only 1.5 GHz available. In this example, due to the insufficient CPU resources available on the edge device, the deployment of the AI model may be deferred or postponed to a later time.

At block 712, the method 700 includes monitoring the one or more system resource metrics associated with the edge device to re-attempt validating a possibility of deployment of the AI model. Continuing with the example, the CPU usage of the edge device may be periodically monitored. In an instance where the CPU usage drops and more processing power is freed up, a re-evaluation may occur to determine whether the available CPU resources now meet or exceed the 2 GHz requirement for the AI model. Based on this re-evaluation, the deployment of the AI model may be determined.

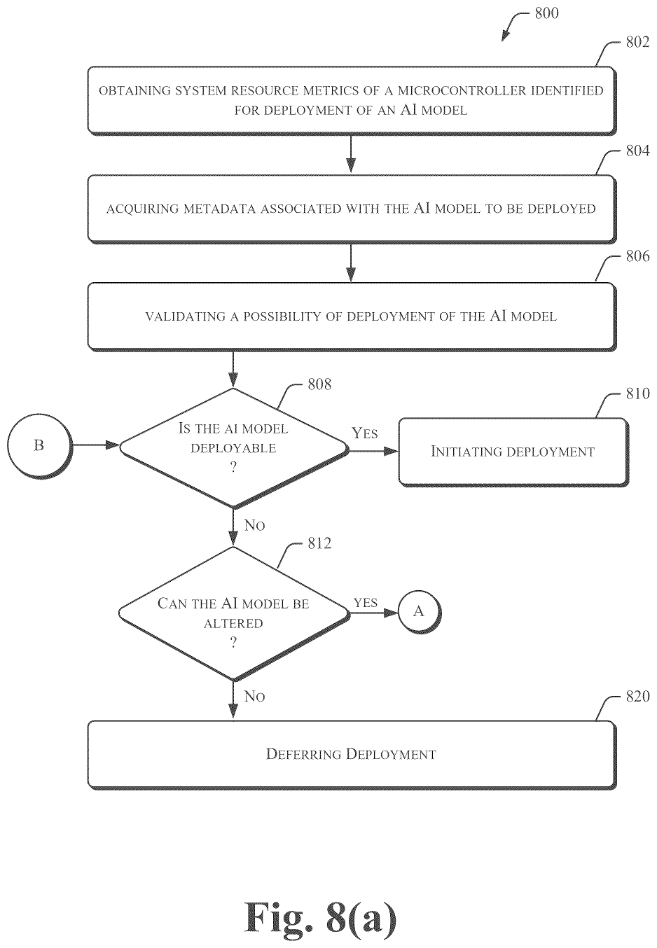

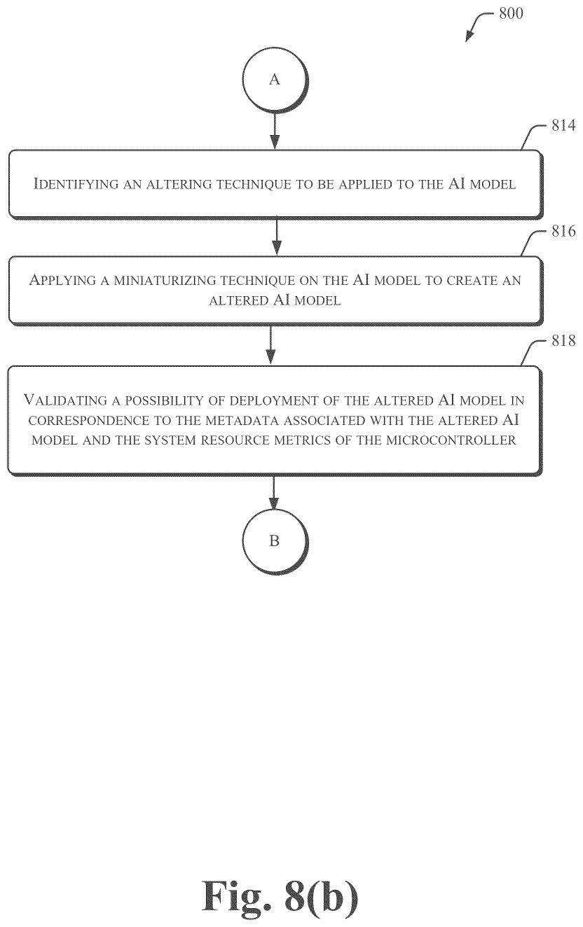

FIG. 8(a) and 8(b) illustrates an example method 800 for deployment of an AI model onto a microcontroller, in accordance with an example implementation of the present subject matter. In FIG. 8(a), at block 802, the method 800 includes obtaining system resource metrics of a microcontroller identified for deployment of an AI model. In one example, a metrics agent coupled to a microcontroller may continuously monitor and publish system resource metrics. For instance, the system resource metrics may indicate a current usage of CPU as 45%, an available RAM of 24 kB, an available flash memory of 64 kB, and a current power consumption of 50 mW.

At block 804, the method 800 includes acquiring metadata associated with the AI model to be deployed, for example, metadata associated with a temperature prediction AI model may be acquired. A name of the model, a version of the model, a framework of the model, and a size of the model may be obtained. In one example, the model may have a TensorFlow Lite framework and be 75 kB in size.

At block 806, the method 800 includes validating a possibility of deployment of the AI model. In one example, a quantitative comparison and a qualitative comparison between the AI model and the microcontroller may be performed. For example, it may be determined whether the TensorFlow Lite framework the model is compatible with the microcontroller's architecture and operating system. Also, it may be determined whether the size of the model is compatible with the available resources of the microcontroller. In one example, on comparing a size of the model and the available memory of the microcontroller, it may be determined that the AI model exceeds the available memory of the microcontroller to host the AI model at a given point in time, where it may be determined that the 75 kB model size exceeds the available 64 kB flash memory.

Based on such comparisons, at block 808, the method 800 may determine if the AI model is deployable onto the microcontroller. In the example discussed above, since the model is not deployable onto the controller in its as-is form, at block 812, the method 800 includes determining whether the AI model can be altered. Accordingly, at block 814, the method 800 includes identifying an altering technique to be applied to the AI model.

At block 816 of the method 800, a miniaturizing technique may be applied to the AI model to create an altered AI model. On miniaturizing the model, metadata associated with the altered model, such as a name of the model, a version of the model, a framework of the model, and a size of the model may be updated and stored. In one example, the altered model may be 58 kB in size.

At block 818, the method 800 includes validating a possibility of deployment of the altered AI model in correspondence to the metadata associated with the altered AI model and the one or more system resource metrics of the microcontroller. In one example, a quantitative comparison may indicate that the altered 58 kB model size is less than the available 64 kB of flash memory. In one example, the availability of the other resources such as the RAM and the CPU usage may be rechecked for compatibility. On re-validating the altered AI model, the method 800 flows back to block 808 to determine if the altered AI model is deployable. On determining that the altered AI model is deployable, at block 810 the method 800 includes initiating deployment of the altered AI model onto the microcontroller through a trusted and secure channel. However, in a scenario where it is determined that the AI model is not deployable, the method 800 at block 820 may initiate deferring deployment of the AI model.

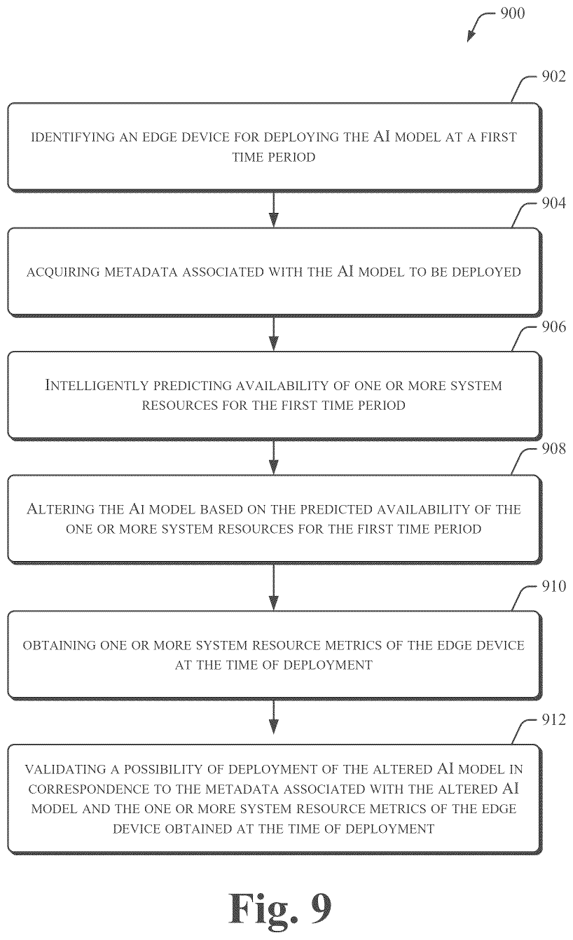

FIG. 9 illustrates an example method 900 for deployment of an AI model, in accordance with an example implementation of the present subject matter. In FIG. 9, at block 902, the method 900 includes identifying an edge device for deploying the AI model at a first time period. In one example, the first time period may be a future point in time, such as after 5 hours, after 10 hours, or the next day, and the like. In one example, the edge device may be selected manually. In another example, an edge device may request for a model to be deployed.

At block 904, the method 900 includes acquiring metadata associated with the AI model to be deployed.

At block 906, the method 900 includes intelligently predicting availability of one or more system resources for the first time period. In one example, predicting the availability of the one or more system resources for the first time period may be based on at least one of historical statistical data associated with an availability of the one or more system resource metrics of the edge device, historical deployment data corresponding to the one or more system resource metrics of the edge device, a current trend of availability and usage of the system resource metric, and historical deployment data associated with the AI model or similar types of AI models. For example, the availability of one or more system resources at 2 p.m. on a particular day may be predicted at 9 a.m., based on historical resource usage patterns and current usage patterns of resources on the edge device. In one example, the available memory at 2 p.m. may be predicted to be 20% lower than the usual availability based on a combination of historical data showing increased resource utilization in the afternoon and a current trend of higher-than-average memory usage.

At block 908, the method 900 includes altering the AI model based on the predicted availability of the one or more system resources for the first time period. Continuing the example, given the prediction of reduced memory availability at 2 PM, the size of the AI model may be decreased. This could involve compressing the model or selecting a smaller variant that requires less memory, ensuring it can still operate effectively within the predicted constraints.

At block 910, the method 900 includes obtaining one or more system resource metrics of the edge device at the time of deployment. In this example, at 2 PM, the actual resource metrics of the edge device may be obtained and monitored, which includes measuring the current available memory, CPU usage, and other relevant system resources, in real-time.

At block 912, the method 900 includes validating a possibility of deployment of the altered AI model in correspondence to the metadata associated with the altered AI model and the one or more system resource metrics of the edge device obtained at the time of deployment. For instance, if the altered AI model now requires 1.5 GB of memory due to the size reduction, and the edge device is found to have 1.8 GB of available memory at 2 PM, deployment of the model would be initiated.

Therefore, by intelligently predicting and adapting to the availability of system resources on an edge device proactively, techniques of the present subject matter ensure efficient use of resources and maintaining system stability, even under varying operational conditions.

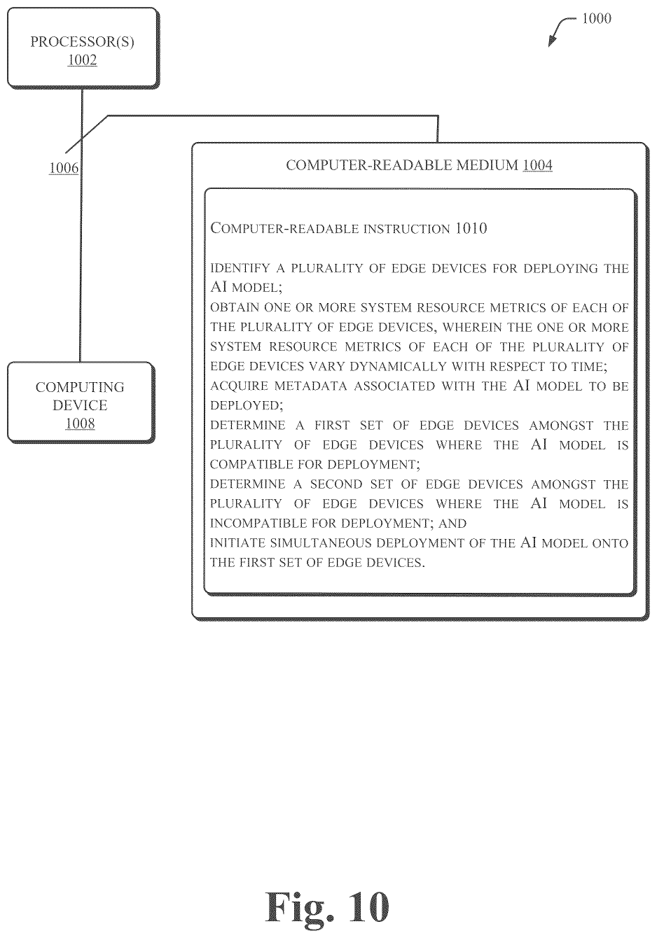

FIG. 10 illustrates a non-transitory computer-readable medium for deployment of an artificial intelligence (AI) model, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system 106 for deployment of an AI model. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for enhancing deployment of an AI model onto an edge device.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for deployment of an AI model. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to identify a plurality of edge devices for deploying the AI model. The instructions 1010 may further cause the processor 1002 to obtain one or more system resource metrics of each of the plurality of edge devices, where the one or more system resource metrics of each of the plurality of edge devices vary dynamically with respect to time and acquire metadata associated with the AI model to be deployed.

Further, the instructions 1010 may cause the processor 1002 to determine a first set of edge devices amongst the plurality of edge devices where the AI model is compatible for deployment, determine a second set of edge devices amongst the plurality of edge devices where the AI model is incompatible for deployment, and initiate simultaneous deployment of the AI model onto the first set of edge devices.

In one example, the instructions 1010 may further cause the processor 1002 to identify a third set of edge devices from amongst the second set of edge devices to alter the AI model for deployment onto the third set of edge devices. Further, in one example, the instructions 1010 being executable by a processor 1002 are to further alter the AI model by compressing the AI model to be deployed onto the third set of edge devices.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/We claim:

1. A method for deployment of an Artificial Intelligence (AI) model, the method comprising:
identifying an edge device for deploying the AI model;
obtaining one or more system resource metrics of the edge device, wherein the one or more system resource metrics of the edge device dynamically vary with respect to time;
acquiring metadata associated with the AI model to be deployed;
validating a possibility of deployment of the AI model in correspondence to the metadata associated with the AI model and the one or more system resource metrics of the edge device, wherein validating the possibility of deployment of the AI model is indicative of determining whether the edge device is capable of hosting the AI model; and
performing at least one of deploying the AI model onto the edge device, altering the AI model for being compatible to be deployed onto the edge device, and deferring deployment of the AI model onto the edge device in correspondence to validating the possibility of deployment of the AI model.

2. The method of claim 1, wherein altering the AI model for being compatible to be deployed onto the edge device includes at least compressing the AI model from a first size to a second size, wherein the second size is compatible with the edge device.

3. The method of claim 1, wherein determining whether the edge device is capable of hosting the AI model includes analyzing historical deployment data corresponding to the one or more system resource metrics of the edge device.

4. The method of claim 1, wherein determining whether the edge device is capable of hosting the AI model includes analyzing historical statistical data associated with an availability of the one or more system resource metrics of the edge device.

5. The method of claim 1, wherein determining whether the edge device is capable of hosting the AI model further comprises performing at least one of a quantitative comparison and a qualitative comparison to assess a compatibility of the AI model and the edge device.

6. The method of claim 5, wherein the quantitative comparison comprises assessing whether a framework of the AI model is compatible with an operating system (OS) version of the edge device.

7. The method of claim 5, wherein the qualitative comparison comprises assessing whether a size of the AI model to be deployed onto the edge device is compatible with a capacity of the edge device to host the AI model.

8. The method of claim 1, wherein deferring deployment of the AI model onto the edge device is performed in correspondence to a quantitative comparison and a qualitative comparison indicating incompatibility between the AI model and the edge device.

9. The method of claim 1, wherein the one or more system resource metrics comprises at least one of an availability of CPU of the edge device and an available memory space of the edge device.

10. The method of claim 1, wherein the deploying of the AI model onto the edge device is performed through a trusted connection layer established between a cloud layer and the edge device to facilitate remote deployment to the edge device.

11. A system for deploying an artificial intelligence (AI) model, the system comprising:
at least one processor;
a memory comprising instructions that, when executed by the at least one processor causes:
a model deployer to:
identify an edge device for deploying the AI model;
obtain one or more system resource metrics of the edge device, wherein the one or more system resource metrics of the edge device dynamically vary with respect to time; and
acquire metadata associated with the AI model to be deployed;
a deployment validator to:
identify the edge device is incapable of hosting the AI model based on the metadata of the AI model and the one or more system resource metrics of the edge device; and
a model altering module to:
determine at least one altering technique to transform the AI model to be deployable onto the edge device; and
alter the AI model in correspondence to the at least one altering technique identified to create an altered AI model; and
wherein the deployment validator is to validate a possibility of deploying the altered AI model onto the edge device.

12. The system of claim 11, wherein the at least one altering technique comprises compressing the AI model from a first size to a second size, wherein the second size is compatible with the edge device.

13. The system of claim 11, wherein determining whether the edge device is capable of hosting the AI model includes analyzing historical deployment data corresponding to the one or more system resource metrics of the edge device.

14. The system of claim 11, wherein determining whether the edge device is capable of hosting the AI model includes analyzing historical statistical data associated with an availability of the one or more system resource metrics of the edge device.

15. The system of claim 11, wherein determining whether the edge device is capable of hosting the AI model further comprises performing at least one of a quantitative comparison and a qualitative comparison to assess a compatibility of the AI model and the edge device.

16. The system of claim 15, wherein the quantitative comparison includes determining whether a framework of the AI model is compatible with an operating system (OS) version of the edge device.

17. The system of claim 15, wherein the qualitative comparison includes determining a compatibility between a size of the AI model to be deployed and a capacity of the edge device to host the AI model.

18. A non-transitory computer-readable medium comprising instructions for deployment of an artificial intelligence (AI) model, the instructions being executable by a processor to:
identify a plurality of edge devices for deploying the AI model;
obtain one or more system resource metrics of each of the plurality of edge devices, wherein the one or more system resource metrics of each of the plurality of edge devices vary dynamically with respect to time;
acquire metadata associated with the AI model to be deployed;
determine a first set of edge devices amongst the plurality of edge devices where the AI model is compatible for deployment;
determine a second set of edge devices amongst the plurality of edge devices where the AI model is incompatible for deployment; and
initiate simultaneous deployment of the AI model onto the first set of edge devices.

19. The non-transitory computer-readable medium as claimed in claim 18, wherein the instructions being executable by a processor are to further: identify a third set of edge devices from amongst the second set of edge devices to alter the AI model for deployment onto the third set of edge devices.

20. The non-transitory computer-readable medium as claimed in claim 19, wherein the instructions being executable by a processor are to further: alter the AI model by compressing the AI model to be deployed onto the third set of edge devices.
